(19) United States
(12) Patent Application Publication
(10) Pub. No.: US 2003/0117995 A1
(43) Pub. Date: Jun. 26, 2003

(54) Method, mobile radiotelephone system, and station for determining a timing advance for a connection between two stations

(75) Inventors: Reinhard Koehn, Berlin (DE); Marcus Purat, Berlin (DE); Joerg Schniedenharn, Berlin (DE); Jean-Michel Traynard, Munchen (DE); Thomas Ulrich, Bad Durkheim (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/220,123

(22) PCT Filed: Feb. 23, 2001
(86) PCT No.: PCT/DE01/00710

(30) Foreign Application Priority Data
Feb. 28, 2000 (DE) 100 09 401.5

(51) Int. Cl. H04J 3/06

(52) U.S. Cl. 370/350; 370/347

(57) ABSTRACT

During the determination of the timing advance (TA), the data is transmitted from the first station (MS) without the timing advance in the form of short radio blocks (B1). After determining the timing advance (TA), the data (D), while taking the timing advance into account, is transmitted from the first station (MS) in the form of long radio blocks (B2) which are longer than the short radio blocks (B1). Both the short radio blocks (B1) as well as the long radio blocks (B2) are transmitted from the first station (MS) in the same channel allocated to the connection.

### DESCRIPTION

The invention relates to a method, a mobile radio telephone system and a station for determining a timing advance for a connection between two stations.

In mobile communications systems with a time division multiplex component (meaning pure TDMA systems and also those with further multiplex component, for example TD-CDMA), the signal transit time between the base station and the mobile station must be taken into account when determining the timing of transmissions of the mobile station. As the mobile station must be synchronized with the base station, it is necessary for it to make its transmissions with a timing advance before the radio blocks received by it. The timing advance compensates the transit time between the mobile station and base station so that the radio blocks arrive at the base station in the correct time slot. When the connection is set up or when the connection is handed over to a new base station, the value of the timing advance must normally be known before the mobile station transmits to the base station the data which is to be transmitted. When the connection is handed over from the old base station to the new base station, the new value of the timing advance can be calculated from the old value if both base stations are synchronized with one another. This is not the case if the changeover takes place between nonsynchronized base stations. Such a case would be, for example, the changeover from an FDD (Frequency Division Duplex) system to a TDD (Time Division Duplex) system.

If the timing advance is still unknown, it is possible, in conventional mobile radio telephone systems, for the mobile station to transmit special access radio blocks (access bursts) only in specific time slots in which what is referred to as RACH (Random Access Channel) is transmitted. By referring to the access bursts, the received base station is capable of determining the signal transit time which occurs, and of determining a corresponding value for the timing advance. This value of the timing advance is then transmitted to the mobile station by the base station. The mobile station is then able to transmit regular radio blocks in any desired time slots, while taking into account the timing advance.

By virtue of the fact that it is necessary to use the RACH to determine the timing advance before the actual user data can be transmitted, the connection setup is delayed. This delay is also prolonged by virtue of the fact that such access operations may collide on the RACH which can be accessed randomly by any mobile station.

WO 96/08885 A discloses a time division multiplex/time division multiple access (TDM/TDMA) communications system in which, before the connection setup, short packets are transmitted in order to determine the timing advance. The short packets contain pilot signals. After the timing advance is determined and after the connection setup, longer packets are transmitted. The longer packets contain user data.

The invention is based on the object of permitting a different method of determining the timing advance. This object is achieved with the method as claimed in claim 1, the mobile radio system as claimed in claim 11 and the station for a mobile radio system as claimed in claim 12. Advantageous embodiments and developments of the invention are the subject matter of the dependent claims.

The invention provides that, during the determination of the timing advance, the data which is transmitted from the first station to the second station is transmitted in the form of short radio blocks without timing advance, and after the determination of the timing advance the data is transmitted, taking into account the time advance, in the form of long radio blocks which are longer than the short radio blocks, both the short radio blocks and the long radio blocks being transmitted by the first station in the channel which is assigned to the connection.

Therefore, in the invention, even before the timing advance for the connection between the mobile station and the base station is known, the same channel is used which is used, after the determination of the timing advance, for the regular transmission of data of this connection. As the channel is one which is assigned individually to this connection, collisions cannot occur with radio blocks of other connections during the determination of the timing advance, as would be the case if RACH were used to determine the timing advance. The individual channel of the connection differs from other channels in the case of a TD/CDMA system, for example in terms of a time slot and its spread code. By virtue of the fact that the short radio blocks are shorter than the long radio blocks which are emitted after the determination of the timing advance, taking into account the timing advance, it is ensured that the short radio blocks are still received in the correct time slot in the receiver even without knowledge of the timing advance. The invention permits connection data to be transmitted immediately even with the first radio blocks so that, for example in the case of a connection handover, it is not necessary to interrupt the transmission of data during the determination of the timing advance.

The invention advantageously permits the timing advance to be determined by the second station (for example the base station) by reference to the short radio blocks transmitted to it by the first station (for example the mobile station).

As the short radio blocks are shorter than the long radio blocks, it is not possible to transmit the same quantity of data within a time slot in both cases. For this reason, according to one development of the invention, there is provision to select the coding rate of a source coding of the data to be transmitted for the data to be transmitted in the short radio blocks to be shorter than for the data to be transmitted in the long radio blocks. This procedure is well suited, for example, to the transmission of voice data. The reduction in the coding rate for the short radio blocks results in this case in a reduction in the quality of the transmitted voice data. Reducing the coding rate of the source coding is to be understood here as a reduction in the source-coded data generated per time unit. For example, instead of a data stream of 15 kbit/sec, only half of this value is obtained from a voice signal.

It is also possible for the coding rate of a channel coding of the data to be transmitted for the data to be transmitted in the short radio blocks to be selected to be higher than for the data to be transmitted in the long radio blocks. This can be carried out, in particular, by reducing the error protection coding, taking place within the scope of the channel coding, of the data to be transmitted. The coding rate of the channel coding is understood here as the ratio of source-coded data to channel-coded data. Increasing the coding rate of the channel coding reduces, as already mentioned, the error protection and the reliability of the data to be transmitted. However, on the other hand, the quantity of source-coded useful data to be transmitted per time slot does not necessarily need to be smaller than in the case of the long radio blocks.

In order to compensate the associated worse error coding of the transmitted data the in the case of a coding rate of the channel coding operation which is increased for the first radio blocks, it is advantageous to increase the transmission power for the short radio blocks in comparison to that for the long radio blocks. This makes the data to be transmitted less susceptible to errors so that the errors occurring to a lesser extent can also still be corrected by the lower degree of error protection coding.

In the case of a TD/CDMA mobile radio telephone system, each radio block is usually provided with a training sequence (midambel) which is specific to the connection and which permits channel estimation in the receiver. The training sequences are often generated here from a common training sequence basic code by means of different rotations.

One development of the invention provides, for this case, that, during the determination of the timing advance, that is to say during the transmission of the short radio blocks which takes place without knowledge of the timing advance, at maximum every second successive training sequence in the direction of the rotation is used for, in each case, one connection maintaining in the respective time slots. As the short radio blocks are transmitted without the timing advance, it is possible that, owing to the resulting chronological offset in the receiver, the rotation of the respective training sequence with respect to the training sequence basic code is cancelled again, at least partially. This can result in the training sequence of the short radio blocks in the receiver being interchanged with another training sequence which actually has a different rotation with respect to the training sequence basic code. However, if, during the transmission of the first radio blocks, only every second, every third or even fewer training sequences are used in the respective radio cell when the first radio blocks are transmitted, training sequences which differ only to a relatively small extent from the training sequence basic code in terms of their rotation are not received in the receiver. Therefore, the risk of interchanging of training sequences which are being used simultaneously owing to the signal transit time between the mobile station and base station is then reduced.

The connection between the two base stations can also be assigned at least two different services, such as a signaling service and a voice service, which are transmitted over the same channel. According to one development of the invention, only a part of the services of the connection, for example only the signaling information, is then transmitted in the short radio blocks, whereas both services, that is to say the voice data as well, are transmitted in the long radio blocks. This also permits the connection to be maintained by means of the short radio blocks which, of course, require a smaller transmission capacity than the long radio blocks.

The invention will be explained in more detail below with reference to exemplary embodiments illustrated in the figures, in which:

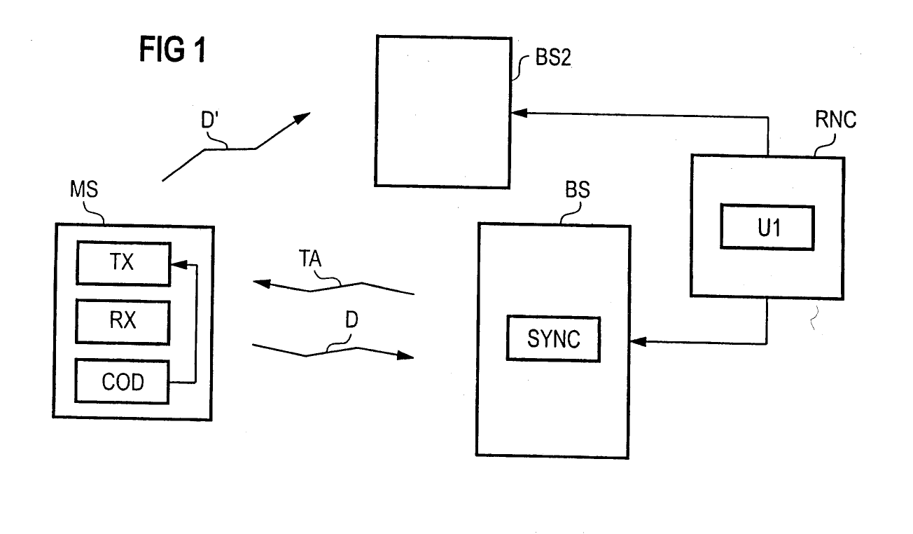

FIG. 1 shows a detail of a mobile radio telephone system according to the invention,

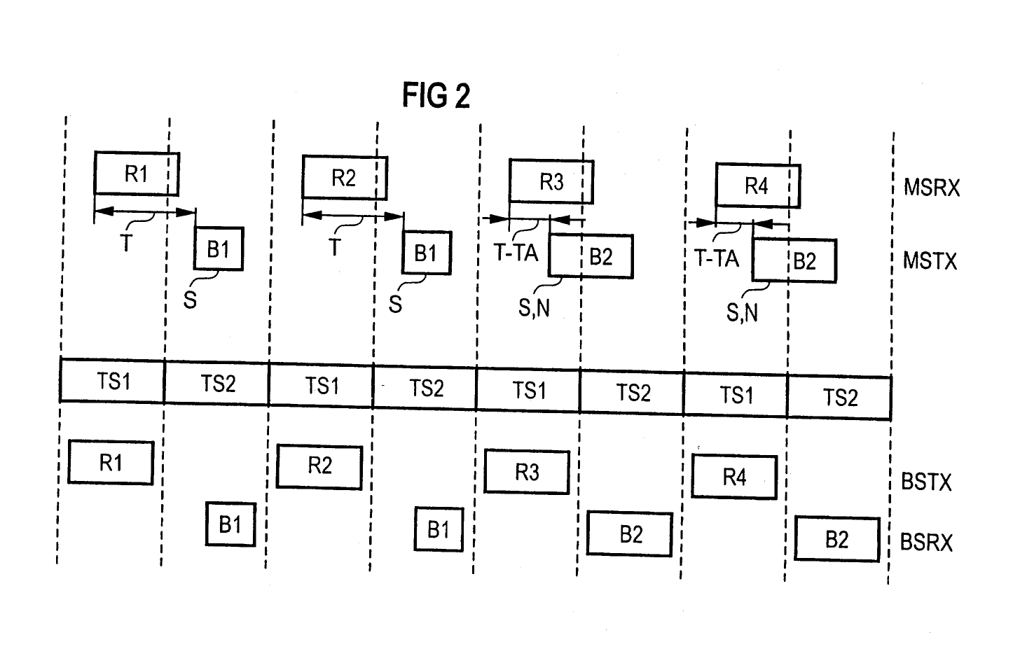

FIG. 2 shows the timing of reception and transmission radio blocks of a mobile station and of a base station of the system from FIG. 1,

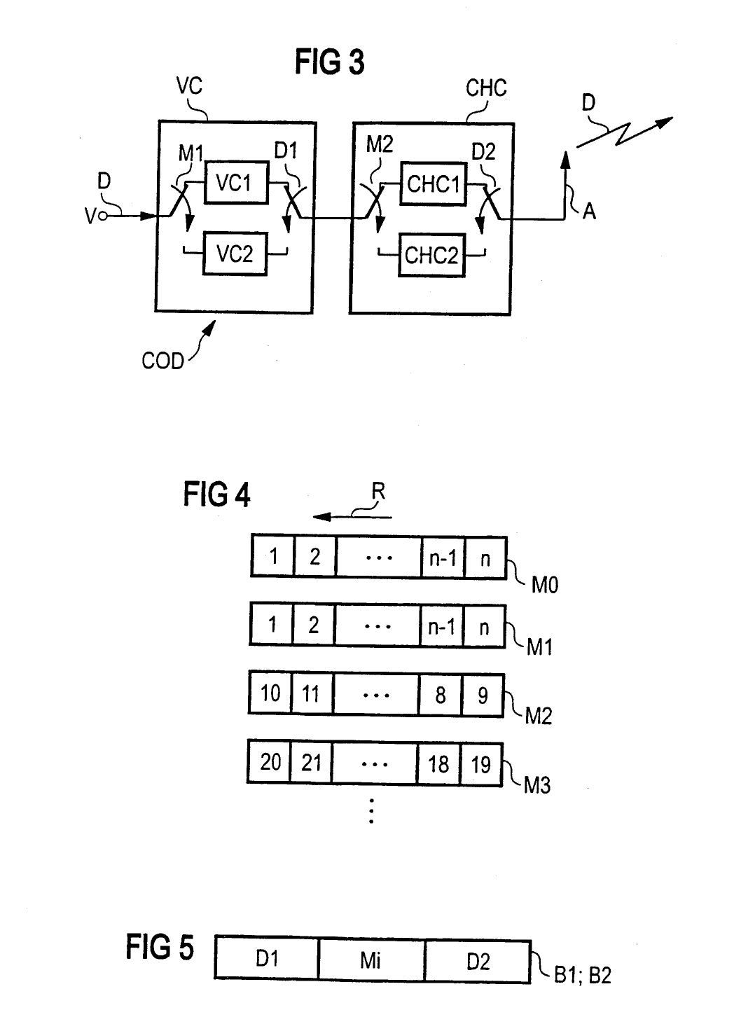

FIG. 3 shows a source coder and a channel coder within a coding unit of a mobile station,

FIG. 4 shows different training sequences for a channel estimation by a receiver, and

FIG. 5 shows a radio block with one of the training sequences from FIG. 4.

The invention will be explained below with reference to a TD/CDMA mobile radio telephone system such as is represented by the UMTS-TDD system, although said invention can also be applied to other systems with a TDMA component.

FIG. 1 shows a mobile station MS and two base stations BS, BS2 of the mobile radio telephone system. The first base station BS is assigned to a TDD system, while the second base station BS2 is associated with a FDD system. The handover of a connection, initially between the mobile station MS and the second base station BS2 of the FDD system, to the first base station BS of the TDD system is considered below. The mobile station MS initially transmits data D′ of the connection to the second base station BS2, and after the handover of the connection, it transmits data D of the connection to the first base station BS. The mobile station MS contains a transmitter unit TX, a receiver unit RX and a coding unit COD, on which details will be given below with respect to FIG. 3. The base station BS has a synchronizing unit SYNCH which determines a timing advance TA for synchronizing the stations MS, BS. The transmission of data D by the transmitter unit TX of the mobile station MS in the uplink direction, and the transmission of data in the downlink direction takes place in the form of radio blocks (bursts). After the determination of the timing advance TA in the base station BS, the latter transmits the value of the timing advance to the mobile station MS. The mobile station MS then takes into account this timing advance in the transmission of the radio blocks and dispatches its radio blocks with a time offset, the timing advance, with respect to radio blocks received by it.

FIG. 1 also shows a base station controller RNC which controls the handover of the connection between the base stations and has, inter alia, a channel assignment unit U1. (Delete U1 in base station BS!).

Before the handover of the connection, the base station controller RNC informs the mobile station MS, via the second base station BS2, which channel has been assigned to it for the connection to the base station BS to which the connection is to be handed over. The mobile station MS is then able to set itself to this channel. The channels of the TD/CDMA system are defined in particular by a specific time slot and a specific spread code.

FIG. 2 shows the reception and the transmission of radio blocks B1, B2, Ri in the mobile station MS and the base station BS with respect to their timing in relation to time slots TS1, TS2 which have been assigned to the connection in the downlink and uplink directions. In the center line of FIG. 2, these time slots TS have been represented for four successive time frames in a simplifying illustration. Here, it is therefore not a case of eight different time slots of a time frame. The time frame time slots which are not assigned to the connection have not been entered in FIG. 2. In addition, the timing conditions have been represented in a highly simplified form for the sake of better understanding. The first row in FIG. 2 contains reception radio blocks MSRX such as are received by the receiver unit RX of the mobile station MS. The transmission radio blocks MSTX of the mobile station MS are represented in the second row in the form in which they are transmitted by said mobile station MS. In the fourth row, the transmission radio blocks BSTX of the base station BS are illustrated, and in the fifth row the reception radio blocks BSRX of the base station BS are illustrated. As the mobile station MS must synchronize with the base station BS, it is necessary to ensure that the radio blocks B1, B2 which are transmitted by the mobile station MS arrive at the base station BS in the correct time slot TS2.

According to FIG. 2, the mobile station MS begins to transmit short radio blocks B1 immediately after the handover of the connection to the base station BS. The base station BS transmits radio blocks Ri to the mobile station MS in the time slot TS1 of each frame. These radio blocks Ri are received (MSRX) in the mobile station MS delayed by the signal transit time. In order to transmit the first radio blocks B1 in the correct time slot TS2, the mobile station MS orientates itself according to the timing pattern of the received radio blocks Ri. The radio blocks MSTX which have been transmitted by the mobile station MS arrive in turn in the base station BS with a delay equal to the signal transit time. As a result of the fact that the short radio blocks B1 have been selected to be correspondingly short in comparison to the length of the time slot TS2, they still arrive at the base station BS within the correct time slot TS2 despite the delay.

By reference to the received short radio blocks B1, the base station BS determines, by means of its synchronzing unit SYNCH, the timing advance TA and transfers it to the mobile station MS. After the mobile station MS has received the timing advance TA from the base station BS, it takes it into account in the Subsequent transmissions. It transmits the following radio blocks B2 with an offset equal to the timing advance TA with respect to the timing pattern T at radio reception blocks MSRX. Taking into account the timing advance TA in the transmission of the radio blocks B2 results in the fact that the start of these radio blocks B2 in the receiving base station BS already occurs at the start of the respective time slots TS. Therefore, the radio blocks B2 which are transmitted taking into account the timing advance TA can be selected to be longer than the short radio blocks B1.

In the exemplary embodiment illustrated in FIG. 2, it is assumed that two types of services, namely signaling information S and voice data N, are to be transmitted in the connection between the mobile station MS and base station BS. As the short radio blocks B1 only permit a low data rate per time slot TS than the long radio blocks B2, only the signaling information S (that is to say the data of the first service) is transmitted in the short radio blocks B1, and the data of all the services is transmitted in the long data blocks B2.

Of course, it is also possible that only the data of one service, for example voice data, is to be transmitted via the connection between the mobile station MS and base station BS. It is then in turn necessary to solve the problem that less data per time slot TS can be transmitted with the short radio blocks B1 than with the long radio blocks B2. FIG. 3 shows two solutions of this problem.

FIG. 3 shows the structure of the coding unit COD of the mobile station MS from FIG. 1. The coding unit COD contains a source coder VC and a channel coder CHC connected downstream thereof. One input of the coding unit COD is supplied with analog voice signals V which correspond to the data D to be transmitted. The source coder VC contains two different voice coders VC1, VC2 which code the voice signals V with different code rates. The voice coders VC1, VC2 are connected at the input end to the input of the coding unit COD via a multiplexer M1, and at the output end to the output of the source coder VC via a demultiplexer D1. The first voice coder VC1 supplies, for example, a data rate of 13 kbit/sec at its output. The second voice coder VC2 supplies only a data rate of 6.5 kbit/sec. As a result of the use of the first voice coder VC1 with the high coding rate, twice as much source-code data is therefore obtained per time unit as when the second voice coder VC2 is used. When the long radio blocks B2 are transmitted, the data contained in them is source-coded by the first voice coder VC1 with the high coding rate. The source coding for the short radio blocks B1 is carried out by means of the second voice coder VC2 with the lower coding rate.

The channel coder CHC in FIG. 3 includes a first channel coding unit CHC1 and second channel coding unit CHC2. These are connected to the input via a multiplexer M2, and to the output at the channel coder CHC via a demultiplexer D2. The radio blocks are transmitted via an antenna A. The coding rate of the first channel coding unit CHC1 is lower than that of the second channel coding unit CHC2. This is due to a greater degree of error protection coding by the first channel coding unit CHC1. The latter therefore adds a greater number of error protection bits to the source-coded data than does the second channel coding unit CHC2. For data transmitted with the long radio blocks B2, the channel coding is carried out by the first channel coding unit CHC1, while the channel coding for the short radio blocks B1 is carried out by means of the second channel coding unit CHC2.

As a result of the use of the different coding rates in the source coding and channel coding, there is a different data rate of the data D to be transmitted via the radio interface. This permits the different length of the radio blocks B1, B2. In other exemplary embodiments of the invention it is, of course, also possible to change only either the source coding rate or the channel coding rate.

FIG. 5 shows the structure of one of the radio blocks B1, B2. A midambel, which is used to carry out channel estimation in the receiver, is inserted as a training sequence Ni between two data items D1, D2.

Furthermore, FIG. 4 shows a plurality of training sequences M1 to M3 which have been produced from the training sequence basic code M0 by means of rotation. The training sequence basic code M0 has n chips. The different training sequence Mi are generated by means of the rotation R in the counterclockwise direction. Each connection in the radio cell of the base station BS is assigned one of the training sequences Mi. The training sequence Mi which is assigned to the respective connection is contained in each of the radio blocks B1, B2 assigned to this connection. In this exemplary embodiment, all the training sequences Mi (and thus the maximum number of simultaneously possible connections) are used, but only during the transmission of the long data blocks B2 by the mobile station. During the transmission of the short radio blocks B1, only every second training sequence M1, M3, . . . is used, so that only half the number of the maximum number of connections possible in the radio cell can be maintained. As a result, interchanging of the different training sequences Mi owing to the signal transit time during the reception in the base station BS is avoided.

The length of the short radio blocks B1 can correspond, for example, to the length of access bursts transmitted in the RACH.

The invention is suitable for application in connection handovers between any base stations which are not synchronized with one another, for example of an FDD base station or GSM base station with a TDD base station, or of a TDD base station with another TDD base station of another mobile radio telephone network. It can also be applied when setting up a connection.

1. A method for determining a timing advance for a connection between two stations (MS, BS) of a mobile radio telephone system,
in which
a channel is assigned to the connection,
data (D) of services of the connection is transmitted in the form of radio blocks (B1, B2) in a timing pattern (TS),
for synchronizing the stations (MS, BS), a timing advance (TA) is determined with which the first station (MS) emits radio blocks with an offset with respect to radio blocks (Ri) received by it,
during the determination of the timing advance (TA), the first station (MS) transmits the data (D) in the form of short radio blocks (B1) without timing advance,
after the determination of the timing advance (TA), the first station (MS) transmits the data (D), taking into account the timing advance, in the form of long radio blocks (B2) which are longer than the short radio blocks (B1),
and both the short radio blocks (B1) and the long radio blocks (B2) are transmitted in the channel by the first station (MS).

2. The method as claimed in claim 1, in which the timing advance (TA) is determined by the second station (BS) by reference to the short radio blocks (B1) transmitted to it by the first station (MS).

3. The method as claimed in claim 1 or 2,
in which the first station (MS) is a mobile station, and the second station (BS) is a first base station
and which is carried out while the connection is handed over from a first base station (BS2) to the first base station (BS) is carried out.

4. The method as claimed in one of the preceding claims,
which is applied to a TDMA mobile radio system,
and in which the channel is assigned to a specific time slot (TS) so that the short radio blocks (B1) and the long radio blocks (B2) are transmitted in this time slot.

5. The method as claimed in claim 4,
which is applied to a CDMA mobile radio system,
and in which the channel is assigned to a specific spread code so that the short radio blocks (B1) and the long radio blocks (B2) are transmitted with this spread code.

6. The method as claimed in one of the preceding claims, in which
source coding (VC) of the data (D) to be transmitted takes place,
and the coding rate of the source coding (VC) for the data to be transmitted in the short radio blocks (B1) is lower than for the data to be transmitted in the long radio blocks (B2).

7. The method as claimed in one of the preceding claims, in which
channel coding (CHC) of the data (D) to be transmitted takes place,
and the coding rate of the channel coding (CHC) of the data to be transmitted in the short radio blocks (B1) is higher than for the data to be transmitted in the long radio blocks (B2).

8. The method as claimed in claim 7, in which the transmitting power of the first station (MS) during the transmission of the short radio blocks (B1) is higher than during the transmission of the long radio blocks (B2).

9. The method as claimed in one of the preceding claims, in which
a plurality of training sequences (Mi) are generated from a common training sequence basic code (M0) by means of different rotations (R),
radio blocks (B1, B2), emitted by transmitter stations of the radio system within a time slot (TS), of different connections each contain one of the training sequences (Mi) for carrying out a channel estimation in the respective receiver (RX),
and, during the determination of the timing advance (TA), at most every second successive training sequence (M0, M2, . . . ) in the direction of the rotation (R) is used for, in each case, one connection maintained in the respective time slots (TS).

10. The method as claimed in one of the preceding claims,
in which
at least two different services (S, N) are assigned to the connection,
only some of the services (S) of the connection are transmitted in the short radio blocks,
and the at least two services (S, N) are transmitted in the long radio blocks.

11. A mobile radio telephone system,
having at least two stations (MS, BS) between which data (D) of services of the connection is transmitted in the form of radio blocks (B1, B2) in a timing pattern (TS),
having an allocation unit (U1) for allocating the connection to a channel,
having a synchronizing unit (SYNC) which, in order to synchronize the stations (MS, BS), determines a timing advance (TA) with which the first station (MS) emits radio blocks with an offset with respect to radio blocks (Ri) received by it,
whose first station (MS) has a transmitter unit (TX) via which, during the determination of the timing advance (TA), it transmits the data (D) in the form of short radio blocks (Bi) without timing advance,
in which, after the determination of the timing advance (TA), the transmitter unit (TX) of the first station (MS) transmits the data (D), taking into account the determined timing advance, in the form of long radio blocks (B2) which are longer than the short data blocks (B1),
and in which the transmitter unit (TX) of the first station (MS) transmits both the short radio blocks (B1) and the long radio blocks (B2) in the channel.

12. A station (MS) for a mobile radio telephone system,
having a transmitter unit (TX) for transmitting data (D) of services of the connection in the form of radio blocks (B1, B2) in a timing pattern (TS) of a channel which is assigned to the station (MS),
having a receiver unit (RX) for receiving a timing advance (TA) with which the transmitter unit (TX) emits radio blocks (B2) with an offset with respect to radio blocks (Ri) received by the station, for the purpose of synchronization with a further station (BS),
whose transmitter unit (TX) transmits, before the reception of the timing advance (TA), the data (D) in the form of short data blocks (B1) without timing advance,
whose transmitter unit (TX) transmits, after the reception of the timing advance (TA), the data (D), taking into account the timing advance, in the form of long radio blocks (B2) which are longer than the short radio blocks.
and whose transmitter unit (TX) transmits both the pg,30 short radio blocks (B1) and the long radio blocks (B2) in the channel.
